(19) United States
(12) Patent Application Publication
(10) Pub. No.: US 2026/0184064 A1
(43) Pub. Date: Jul. 2, 2026

(54) PRINTING APPARATUS AND METHOD OF PRODUCING PRINTED OBJECT

(71) Applicant: Shuhou Co., Ltd., Fukui-shi, Fukui (JP)

(72) Inventor: Kouji MURAOKA, Sabae-shi, Fukui (JP)

(73) Assignee: Shuhou Co., Ltd., Fukui-shi, Fukui (JP)

(21) Appl. No.: 18/858,548

(22) PCT Filed: Nov. 2, 2023
(86) PCT No.: PCT/JP2023/039575

§ 371 Date: Oct. 21, 2024

(51) Int. Cl. B41F 17/00; B41F 15/36; B41F 15/42

(52) U.S. Cl. CPC B41F 17/001; B41F 15/36; B41F 15/42; B41F 17/006

(57) ABSTRACT

A printing apparatus includes: a printing pad having a printing surface that is deformable in such a manner as to conform to a shape of a surface to be printed of the object to be printed; a printing original plate including a deposition surface on which ink is to be placed; a printing original plate stage on which a printing original plate is placed; and an ink depositing device configured to deposit the ink on the surface of the printing original plate. The printing pad is configured to be movable between the printing original plate stage and the object to be printed, and to be pressed against the printing original plate stage or the object. The ink depositing device includes a screen including openings through which the ink passes and a squeegee configured to slide over a surface of the screen.

### TECHNICAL FIELD

The present disclosure relates to a printing apparatus and a method of producing a printed object, and in particular, to a printing apparatus that performs printing by moving a printing pad and pressing a printing surface thereof against a surface to be printed, and a method of manufacturing a printed object.

### BACKGROUND ART

As an apparatus that prints characters and an image such as a picture, a printing apparatus using a printing pad has been known. The printing apparatus prints a print pattern on a surface to be printed, by pressing a printing surface of the printing pad against a printing original plate, transferring to the printing pad, ink that is deposited on the printing original plate according to the print pattern, and pressing the printing surface of the printing pad to which the ink has been transferred, against the surface to be printed, thereby transferring the ink transferred to the printing surface to the surface to be printed. In the printing original plate, ink is deposited on a surface of the printing original plate, for example, by ink-jet, or the printing original plate is formed such that a fine dot pattern is carved to hold ink in projection portions or recess portions. The printing pad is pressed against the printing original plate, and the ink is thus transferred to the printing pad (for example, see Patent Literature 1).

In the related art, in coating an automobile body, a middle coat, baking, a topcoat base coat, a topcoat clear coat, and baking are successively performed on a coated object subjected to, for example, electrodeposition coat and baking as an undercoat. In the base coat, for example, water-soluble or water-dispersible paint such as emulsion, or organic solvent paint, which contains a resin component and a pigment component, is used. The coat is performed by, for example, an air spraying method, an airless splaying method, an electrostatic coating method, or a bell coating method, and the paint is blown to the automobile body by a coating robot. After a coating layer is formed on the automobile body, baking is performed (for example, see Patent Literature 2).

### CITATION LIST

### Patent Literature

Patent Literature 1: Japanese Patent No. 7297141.

Patent Literature 2: Japanese Patent No. 7091385.

### SUMMARY OF INVENTION

### Technical Problem

Printing by fine dots of ink that is disclosed in Patent Literature 1 is suitable for the case of transferring a high-resolution image to a surface of an object to be printed. However, for example, in the case where printing is performed on a surface of an automobile body, the ink of fine dots is not sufficient to ensure strength and durability of an ink layer that is formed on the surface. By contrast, in the coating of the automobile body disclosed in Patent Literature 2, paint is blown in a mist form, and it is therefore necessary to provide, for example, a ventilation apparatus in a coating booth or a processing apparatus for ventilated air. Accordingly, this coating requires large-scale facilities in addition to a coating apparatus.

The present disclosure is applied to solve the above problems, and relates to a printing apparatus and a method of producing a printed object that can both obtain an ink layer that achieves a high strength of a print image that is formed on a surface of an object to be printed, without requiring a large-scale facility.

### Solution to Problem

A printing apparatus according to one embodiment of the present disclosure includes: a printing pad having a printing surface that is deformable in such a manner as to conform to a shape of a surface to be printed of an object to be printed; a printing original plate having a deposition surface on which ink is to be placed; a printing original plate stage on which the printing original plate is placed; and an ink depositing device configured to deposit the ink on the surface of the printing original plate. The printing pad is configured to be movable between the printing original plate stage and the object, and to be pressed against the printing original plate stage or the object. The ink depositing device includes a screen including openings through which the ink passes and a squeegee configured to slide over a surface of the screen.

A method of producing a printed object according to another embodiment of the present disclosure is a method of producing a printed object by pressing a printing surface of a printing pad against a surface to be printed of the object to be printed to transfer ink deposited on the printing surface, thereby forming an ink layer on the surface to be printed, the method including: depositing the ink on a surface of a printing original plate by sliding a squeegee along a surface of a screen after the ink is deposited on the screen, and causing the ink to pass through openings provided in the screen; transferring the ink deposited on the printing original plate to the printing surface by pressing the printing surface against the printing original plate on which the ink is deposited; and pressing the printing surface against the surface of the object to be printed while deforming the printing surface in such a manner as to conform to the surface of the printed matter, thereby forming the ink layer.

### Advantageous Effects of Invention

According to the embodiment of the present disclosure, ink is deposited on the printing original plate by using the screen and the squeegee, and the ink is transferred to the printing pad and is then transferred to the surface to be printed of the object to be printed, whereby it is possible to form an ink layer on the surface to be printed without atomizing the paint. In addition, since the ink is deposited on the printing original plate by using the screen, it is possible to increase the thickness of the ink transferred from the printing original plate to the printing pad, to ensure a sufficient thickness of the ink layer formed on the surface to be printed, and to perform printing that achieves a high strength and high durability. It should be noted that the ink for use in the embodiment of the present disclosure is not limited to the paint for use in the related art, and any of a larger number of kinds of ink can be selected as the ink for use in the embodiment as long as the ink can pass through holes of the screen. Thus, a larger number of materials are available for selection.

### BRIEF DESCRIPTION OF DRAWINGS

FIG. 1 a schematic view in the case where printing is performed on an object 70 to be printed, by using a printing pad 10 according to Embodiment 1.

FIG. 2 is a side view illustrating an example of the printing apparatus 100 according to Embodiment 1.

FIG. 3 is a sectional view illustrating an example of a printing pad 10 provided in the printing apparatus 100 according to Embodiment 1.

FIG. 4 is a schematic view of a sectional configuration of an ink depositing device 20 according to Embodiment 1.

FIG. 5 is a schematic view of a step of depositing ink 40 on a printing original plate 50 by using the ink depositing device 20 as illustrated in FIG. 4.

FIG. 6 illustrates an example of a detailed structure of a screen 21 according to Embodiment 1.

FIG. 7 indicates a flow of a method of producing the printed object 70 using the printing apparatus 100 according to Embodiment 1.

FIG. 8 illustrates a flow of operation of the printing apparatus 100 according to Embodiment 1.

FIG. 9 illustrates a detailed flow of operation in an ink deposition step (S1) according to Embodiment 1.

FIG. 10 illustrates a modification of the printing pad 10 for use in the printing apparatus 100 of Embodiment 1.

FIG. 11 is an enlarged schematic view of a printing surface 4 of the printing pad 10 according to Embodiment 1.

### DESCRIPTION OF EMBODIMENTS

### Embodiment 1

A printing apparatus and a method of producing a printed object according to an embodiment of the present disclosure will be described below with reference to drawings. The present disclosure is not limited by the embodiment. In each of figures in the drawings, components that are the same as those in a previous figure or previous figures are denoted by the same reference sins, and their descriptions will thus be omitted.

### Object 70 to be Printed

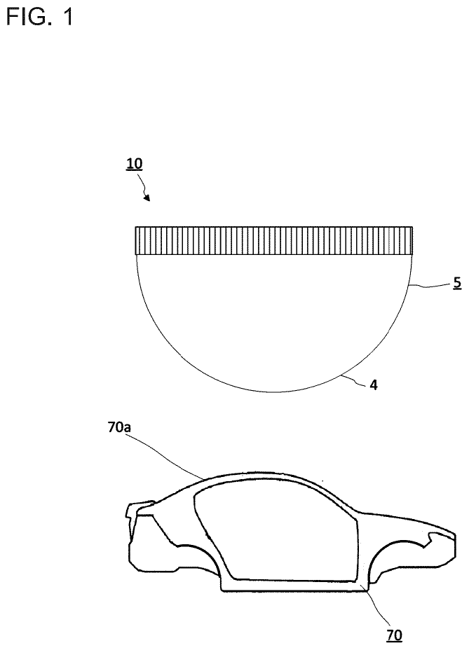

FIG. 1 is a schematic view in the case where printing is performed on an object 70 to be printed, by using a printing pad 10 according to Embodiment 1. The object 70 is, for example, a body, a door, and a hood of an automobile. The body and other parts of the automobile are formed by, for example, plastically deforming metals and joining the metals by means such as welding. Surfaces of the body and other parts of the automobile are subjected to coating after being subjected to cleaning, surface treatment, plating, and other treatment. The surfaces of the body and other parts of the automobile are combinations of curved surfaces. In the related art, the coating is carried out by spraying paint on the surfaces by using means such as an air spray. Embodiment 1 will be described with respect to the case where an ink layer is formed on the body of the automobile by using the printing pad 10. It should be noted that the shape of the object 70 to be printed as illustrated in FIG. 1 is an example, and the shape of a surface 70a to be printed can be appropriately changed. The object 70 is not limited to the body and other parts of the automobile, and can be appropriately changed to, for example, a material or surface treatment performed on the surface 70a to be printed.

### Printing Apparatus 100

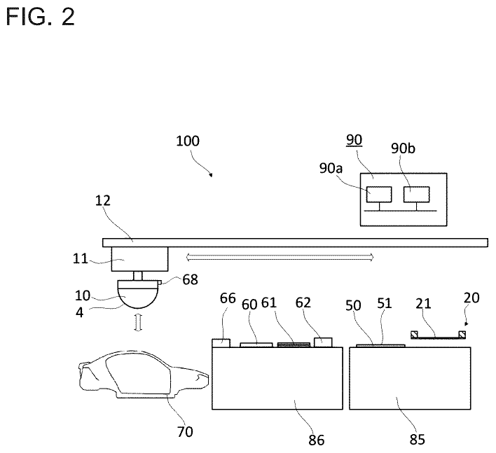

FIG. 2 is a side view illustrating an example of a printing apparatus 100 according to Embodiment 1. The printing apparatus 100 includes the printing pad 10 that is linearly movable in an up-down direction. The printing pad 10 is moved in the up-down direction by an up-down-direction moving device 11 provided in the printing apparatus 100, and a printing surface 4 is pressed against the surface to be printed of the object 70 to be printed. In Embodiment 1, the printing pad 10 is pressed against the surface 70a. The printing apparatus 100 further includes a horizontally moving device 12. The horizontally moving device 12 moves the printing pad 10 and the up-down-direction moving device 11 in a horizontal direction. Referring to FIG. 2, the printing pad 10 is linearly moved in the up-down direction and pressed against the surface 70a; however, for example, the printing pad 10 may be moved in the horizontal direction and pressed against the surface 70a. The printing pad 10 may be moved and pressed by using, for example, a robot arm. In this case, for example, the printing pad 10 is attached to a robot having an articulated arm instead of the up-down-direction moving device 11 and the horizontally moving device 12, and the printing pad 10 is moved between a printing original plate 50 and the object 70 to be printed.

The printing pad 10 is moved by the horizontally moving device 12 to a position located above a cleaning device 60, an activation device 61, an air blowing device 62, or the printing original plate 50 in addition to the object 70. The printing pad 10 is moved in the up-down direction by the up-down-direction moving device 11, and the printing surface 4 is pressed against each of the object 70, the cleaning device 60, the activation device 61, and the printing original plate 50. Referring FIG. 2, the printing apparatus 100 includes a region where the object 70 is located, a surface treatment stage 86 including the cleaning device 60, and a printing original plate stage 85 in turn from the left. The surface treatment stage 86 includes the activation device 61 and the air blowing device 62. The printing original plate 50 is deposited on the printing original plate stage 85. However, in the printing apparatus 100, these stages can be freely arranged, and the arrangement can be appropriately changed depending on the convenience of a worker and a location where the printing apparatus 100 is installed. In some cases, the cleaning device 60, the activation device 61, and the air blowing device 62 are not provided in the printing apparatus 100. In addition, for example, a jig and a stage on which the object 70 is placed may be disposed in the region where the object 70 is located.

### Printing Pad 10

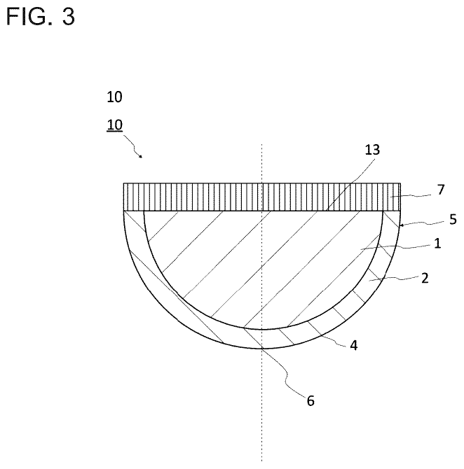

FIG. 3 is a sectional view illustrating an example of the printing pad 10 provided in the printing apparatus 100 according to Embodiment 1. FIG. 3 illustrates a section that passes through an apex 6 of the printing pad 10 and that is perpendicular to a flat surface 13 to which a base 5 is fixed. The printing pad 10 as illustrated in FIG. 3 has, for example, a substantially hemispherical shape. However, the shape of the printing pad 10 is not limited to the substantially hemispherical shape, and can be appropriately changed to, for example, a cannonball shape, a shape having a curved surface obtained by rotating a parabola about a symmetrical axis thereof, a shape of a portion obtained by cutting an ellipsoid, or a shape obtained by continuously extending a cross-section having a cannonball shape or a semicircular shape in a straight line, based on specifications of the object 70 to be printed. The base 5 of the printing pad 10 includes an internal layer 1 and an external layer 2 covering a surface of the internal layer 1. However, the structure of the printing pad 10 is not limited to a two-layer structure, and may be a single layer structure or a multilayer structure. An outer surface of the internal layer 1 has a shape obtained by causing an outer surface of the external layer 2 to be inwardly offset, but its shape is not limited to such an obtained shape. Irregularities may be provided at the outer surface of the internal layer 1. A cavity may be provided inside the printing pad 10.

The printing pad 10 includes the apex 6 that is first brought into contact with the object 70 to be printed or the printing original plate 50, and the apex 6 is formed in the shape of a point or a line. Therefore, when the printing pad 10 is pressed against the object 70 or the printing original plate 50, the printing pad 10 does not catch air between the printing surface 4 and the object 70 or between the printing surface 4 and the printing original plate 50. It is therefore possible to prevent a void from appearing in a print image that is printed on the object 70. In Embodiment 1, a predetermined range of the surface of the printing pad 10 that is centered around the apex 6 serves as the printing surface 4 that receives ink from the printing original plate 50 and transfers the ink to the object 70.

### Base 5

For example, a silicon rubber is molded, thereby forming the base 5. The base 5 has elasticity (flexibility), and is mixed with silicone oil in order that the base 5 be easily deformed. In Embodiment 1, the base 5 has a substantially hemispherical shape, but its shape can be appropriately changed based on the specifications of the object 70 to be printed. The base 5 is deformed when the printing pad 10 is pressed against the printing original plate 50, the printing surface 4 comes into close contact with the printing original plate 50 along a surface thereof, and ink 41 deposited on a deposition surface 51 of the printing original plate 50 is transferred to the printing surface 4. The ink 41 deposited on the deposition surface 51 of the printing original plate 50 is located based on an image to be printed on the object 70, and forms a print pattern corresponding to the image. It should be noted that the material of the base 5 is not limited, that is, any material can be used as long as the base 5 can transfer the ink 41 to the surface to be printed when the printing pad 10 is pressed against the surface 70a to be printed.

For example, the base 5 may be made of two materials different hardness. In this case, for example, the material of the external layer 2 forming a portion of the base 5 that is close to the printing surface 4 is set to have Asker-C hardness that falls within the range of 10 points to 20 points. The material of the internal layer 1 inside the external layer 2 is set to have Asker-C hardness within the range of 20 to 40 points. The internal layer 1 is located on a side on which a force that presses the printing surface 4 against the surface to be printed is applied at the time of performing printing, and is located closer to a supporting member 7 than the external layer 2. The supporting member 7 is connected to the up-down-direction moving device 11, and transfers a force from the up-down-direction moving device 11 to the printing pad 10. In order that the printing pad 10 be deformed to conform to the surface 70a to be printed, it is preferable that the hardness of the printing pad 10 be set low. Therefore, in the printing pad 10, the hardness of a portion of the printing surface 4 that is pressed against the object 70 to be printed is set lower than hardness of the internal layer 1. Because of such a configuration, the entire shape of the printing pad 10 is formed such that the printing pad 10 to be easily held. In addition, the external layer 2 that is directly pressed against the surface to be printed is easily deformed such that its shape is changed to a three-dimensional shape of the surface to be printed. However, the hardness of each of the portions of the base 5 is not limited to the above hardness.

### Cleaning Device 60

As illustrated in FIG. 2, the surface treatment stage 86 is provided adjacent to the printing stage 87 of the printing apparatus 100. The cleaning device 60 is provided on the surface treatment stage 86. The cleaning device 60 includes, for example, paper or an adhesive tape. The printing surface 4 of the printing pad 10 is pressed against a surface of the paper or the adhesive tape, whereby, for example, the ink 41, stains, or dusts that remains after printing are removed.

### Activation Device 61

The activation device 61 includes a storage tank that stores liquid and an absorption unit that absorbs and holds the liquid. When the printing surface 4 of the printing pad 10 is pressed against a surface of the absorption unit, the liquid held by the absorption unit adheres to the printing surface 4 of the printing pad 10. When water or a solvent is caused to adhere to or permeate into the base 5, the printing pad 10 easily transfers the ink 41 deposited on the printing original plate 50 to the printing surface 4. The liquid is appropriately selected based on its properties for components contained in the ink 41, and has properties for softening the hard ink 41. The ink 41 is a mixture of a synthetic resin such as an acrylic resin or a urethane resin, and water, thinner, xylene, toluene, or other substance. It is appropriate that as the liquid for use in the activation device 61, liquid having high affinity for materials contained in the ink 41 is selected. However, the liquid for use in the activation device 61 is not limited to the above liquid.

The absorption unit of the activation device 61 is formed such that, for example, absorbers each having a thin sheet shape are stacked together. The absorbers are made of, for example, paper, but is not limited to the paper. The absorbers may be made of other material such as a cloth or a resin as long as the absorbers absorb the liquid. For example, the absorption unit may be a unit in which pieces of paper are stacked on a sponge resin. In some cases, the surface of the absorption unit against which the printing surface 4 of the printing pad 10 is pressed dries, or stains such as the ink 41 remaining on the printing surface 4 of the printing pad 10 adhere to the surface of the absorption unit, or the paper forming the absorption unit is torn when the surface of the absorption unit is rubbed. Therefore, the absorption unit is configured such that the paper that forms the uppermost layer of the absorption unit can be peeled and removed from the uppermost layer of the absorption unit, and the stacked pieces of paper can be removed one by one, or an upper layer portion can be mechanically replaced by another one. However, a method of replacing the paper located on the uppermost layer by another one is not limited to the above method. The absorption unit is configured such that the paper forming the uppermost layer can be removed or replaced by another one, and the surface can be kept clean. In addition, the absorption unit is impregnated with the liquid. Therefore, the printing surface 4 of the printing pad 10 can be activated by being pressed against the absorption unit. It should be noted that the configuration of the activation device 61 is not limited to the above configuration, and may be other configurations.

### Air Blowing Device 62

The air blowing device 62 adjusts and sets the amount of water or solvent that adheres to the printing surface 4 of the printing pad 10, using the activation device 61, to an appropriate amount. The air blowing device 62 blows air to the printing surface 4 to remove excess water or excess solvent from the printing surface 4. It should be noted that the type of the air blowing device 62, the number of air blowing devices 62, and an air blowing direction of the air blowing device 62 are not limited.

### Printing Original Plate Stage 85

On a top surface of the printing original plate stage 85, the printing original plate 50 is placed, and the printing original plate stage 85 includes an ink depositing device 20 that deposits ink on the printing original plate 50. To be more specific, the ink depositing device 20 deposits the ink 41 on the surface of the printing original plate 50, using a screen 21. On the printing original plate stage 85, the printing original plate 50 is placed, and the printing original plate stage 85 is configured such that the ink depositing device 20 can be located above the printing original plate 50 when the ink 41 is deposited on the printing original plate 50. Furthermore, the printing original plate stage 85 is configured such that the ink depositing device 20 can be retreated from a region located above the printing original plate 50 at the time of transferring the ink 41 from the printing original plate 50 to the printing pad 10. The ink depositing device 20 may be configured to be movable in the horizontal direction or the up-down direction in the region located above at least the printing original plate 50 by a feeding device (not illustrated). Alternatively, the printing original plate 50 may be configured to be movable relative to the ink depositing device 20. In any case, the ink depositing device 20 or the printing original plate 50 is configured to be movable to a position in which the ink depositing device 20 does not obstruct pressing of the printing pad 10 against the printing original plate 50. Referring FIG. 2, the printing original plate 50 is set on the printing original plate stage 85; however, for example, a surface of the printing original plate stage 85 may be configured to serve as the printing original plate.

The printing original plate stage 85 may be configured freely movable relative to the printing apparatus 100. For example, the printing original plate stage 85 may include a device for movement, such as wheels, and the layout of the printing original plate stage 85 may be freely changed relative to devices forming the printing apparatus 100, as necessary. In other words, the printing original plate stage 85 may be moved and placed alongside of each of the devices that form the printing apparatus 100 other than the printing original plate stage 85, and may be placed alongside of another printing apparatus 100 as necessary. In this case, the ink depositing device 20 and the printing original plate 50 may be set on the printing original plate stage 85, and the printing pad 10 may be pressed against the printing original plate 50 by a robot arm, for example. Alternatively, the printing original plate 50 on which the ink 40 is deposited from the printing original plate stage 85 may be moved to a main body of the printing apparatus 100. When the printing original plate stage 85 is configured to be movable, a plurality of printing apparatuses 100 can share the ink depositing device 20 and the printing original plate 50, and a plurality of printing steps can be carried out by one ink depositing device 20. The surface treatment stage 86 may also be configured to be movable, and each of the cleaning device 60, the activation device 61, and the air blowing device 62 may also be configured to be movable.

### Ink Depositing Device 20

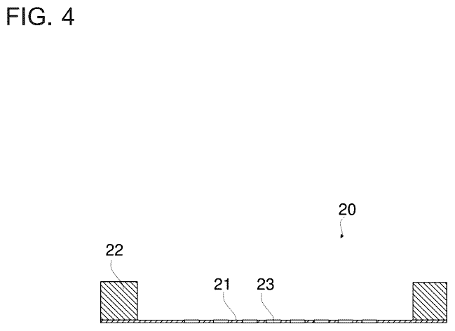

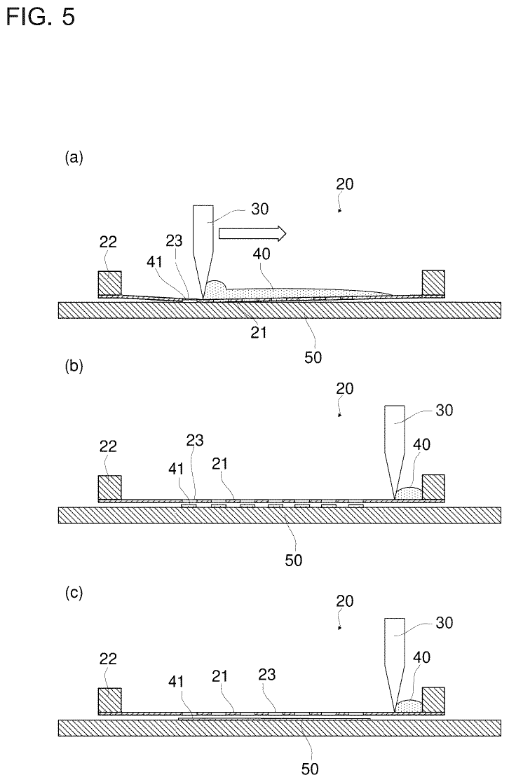

FIG. 4 is a schematic view illustrating a sectional configuration of the ink depositing device 20 according to Embodiment 1. FIG. 5 is a schematic view for a step of depositing ink 40 on the printing original plate 50, using the ink depositing device 20 as illustrated in FIG. 4. The ink depositing device 20 includes a screen 21 fixed to a screen frame 22. The ink 40 deposited on the screen 21 passes through openings 23 and is deposited on the printing original plate 50. As illustrated in FIG. 5, (a), when a squeegee 30 slides over a surface of the screen 21, the ink 40 passes through the openings 23 and is then deposited on the surface of the printing original plate 50. The squeegee 30 is a member having a spatula shape, and slides, with its distal end pressed against the surface of the screen 21. The squeegee 30 is made of, for example, a rubber or a resin material. The squeegee 30 presses the screen 21 and the ink 40 against the printing original plate 50 while moving in such a manner as to scrape the ink 40 on the screen 21, thereby depositing the ink 41 on the surface of the printing original plate 50.

As illustrated in FIG. 5, (b) and (c), when the squeegee 30 moves while being pressed against the screen 21 on which the ink 40 is deposited, the ink 41 that has passed through the openings 23 adheres to the printing original plate 50, and the ink 41 is deposited on the printing original plate 50. In the case where the openings 23 are arranged apart from each other by a sufficient distance, drops of the ink 41 that has passed through the openings 23 are independently deposited on the printing original plate 50 as illustrated in FIG. 5, (b). In the case where the viscosity of the ink 41 is low and the distances between the openings 23 are small, drops of the ink 41 are deposited with no gap on the printing original plate 50 as illustrated in FIG. 5, (c).

### Screen 21

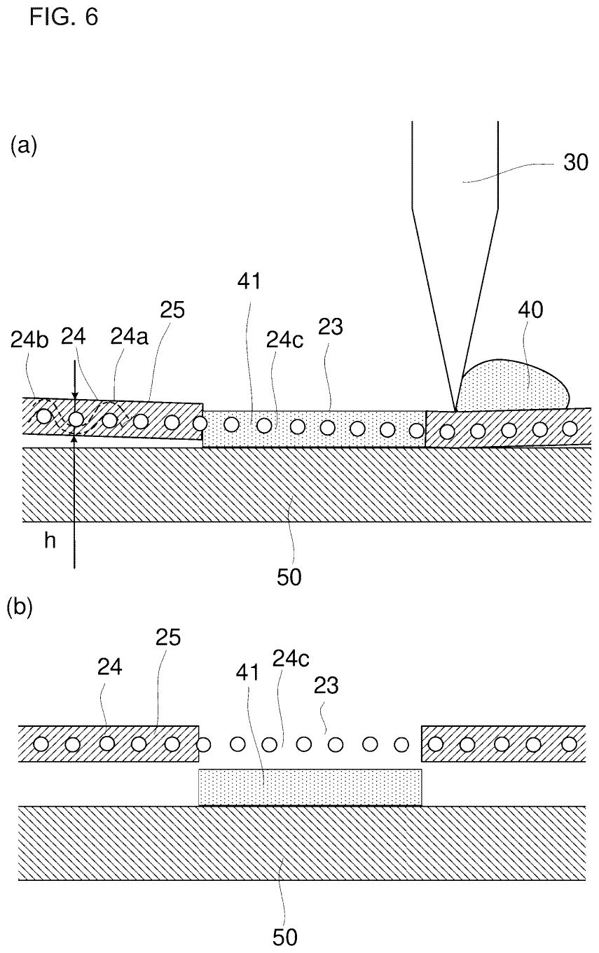

FIG. 6 illustrates an example of a detailed structure of the screen 21 according to Embodiment 1. For example, a mesh member 24 obtained by weaving fibers in a mesh shape is coated with emulsion 25, thereby forming the screen 21. The emulsion 25 partially covers a mesh structure of the screen 21 to form a portion that does not allow the ink 40 to pass through the screen 21. The emulsion 25 is, for example, liquid that is cured by UV irradiation. The screen 21 is created in such a manner that the mesh member 24 is coated with the emulsion 25, masks are applied to cause portions other than portions where the openings 23 are to be provided, to be irradiated with UV, the entire screen 21 is irradiated with UV, and the uncured emulsion 25 is removed. By applying such a way, the openings 23 allowing the ink 40 to pass therethrough and portions not allowing the ink 40 to pass therethrough are formed in the mesh member 24.

The squeegee 30 slides over the surface of the screen 21 to cause the openings 23 to be filled with the ink 40 deposited on the screen 21. In addition, as illustrated in FIG. 6, the squeegee 30 slides over the screen 21 upon receiving a load toward the screen 21, thereby bringing the ink 41 filled in the openings 23 into contact with the printing original plate 50. As a result, the ink 41 is transferred to the printing original plate 50. When the ink 41 is pressed against the printing original plate 50 by the squeegee 30 as illustrated in FIG. 6, (a), and the screen 21 is then separated from the printing original plate 50 as illustrated in FIG. 6, (b), the ink 41 remains on the printing original plate 50. The thickness of the ink 41 disposed on the deposition surface of the printing original plate 50 depends on the thickness h of the screen 21. For example, when the thickness h of the screen 21 is increased, the thickness of the ink 41 is also increased, and when the thickness h of the screen 21 is decreased, the thickness of the ink 41 is also decreased.

In the case where the screen 21 is obtained by coating the mesh member 24 with the emulsion 25, the thickness h of the screen 21 is determined based on the thickness of the mesh member 24 formed by weaving the fibers and the emulsion 25 applied for the coating. The mesh member 24 is formed by weaving fibers in the vertical and lateral directions. Therefore, the mesh member 24 has a thickness having not only the thickness of fibers 24a appearing in a section illustrated in FIG. 6, (a) but also the thickness of fibers 24b woven in such a manner as to intersect with the fibers 24a. The thickness h of the screen 21 is that in the state where the mesh member 24 is coated with the emulsion 25. However, in the case where the openings 23 provided in the screen 21 are located in a wide range, the thickness h of the screen 21 may be equal to the thickness of the mesh member 24. Furthermore, in a certain object 70 to be printed, the openings 23 are not provided in part of the screen 21; that is, the entire region of the screen 21 serves as an opening portion including the openings 23.

The mesh member 24 is formed by weaving, for example, resin fibers or metal fibers, and gaps 24c of the woven fibers 24a and 24b are aggregated to form the openings 23. For example, the mesh member 24 is configured such that the fibers 24a and 24b are arranged at regular intervals, and each of the intervals and the diameter of each of the fibers 24a and 24b are substantially equal to each other. The mesh member 24 is not limited to the mesh member formed by weaving the fibers, and may be formed by pressure-bonding fibers extending in the vertical and lateral directions. Furthermore, the mesh member 24 may be formed such that a plurality of through holes are provided in a metal plate. Alternatively, in the mesh member 24, material such as a resin plate or a film may be used in place of the metal plate. In the case where the plurality of through holes are provided in the metal plate, the plurality of through holes may be formed at portions where the openings 23 are to be formed, by, for example, laser processing. The emulsion may be applied to a metal plate having the plurality of through holes in the entire region thereof, and the emulsion is fixed to at least part of the metal plate that is other than the openings 23 to close part of the plurality of through holes, thereby forming the openings 23. It should be noted that the emulsion may be another substance as long as the substance can be solidified to form the openings 23. For example, the ink may be solidified, or an adhesive may be used.

In the case where the screen 21 is formed such that the plurality of through holes are provided in a thin metal plate, the thickness of the metal plate is equal to the thickness h of the screen 21. In the case where the screen 21 is formed such that the thin metal plate is coated with the emulsion 25, the total thickness of the thin metal plate and the emulsion 25 is equal to the thickness h of the screen 21. In the case where the screen 21 is made of a thin metal plate, and the openings 23 provided in the screen 21 are located in a wide range, in some cases, the thickness h of the screen 21 is equal to the thickness of the mesh member 24.

### Advantages Obtained by Depositing Ink 41 on Printing Original Plate 50 Using Screen 21

In printing using the screen 21 according to Embodiment 1, the ink 41 can be deposited on the printing original plate 50 in such a manner as to adapt to so-called solid printing (printing in which a predetermined print region of the surface 70a to be printed of object 70 is filled with ink 41 without any gaps). For example, In the case of using the printing apparatus 100 according to Embodiment 1, the ink 41 can be relatively thickly deposited on the printing original plate 50 because of provision of the screen 21. In the printing apparatus 100, the printing pad 10 is pressed against the printing original plate 50 to transfer the ink 41 to the printing surface 4, and the printing surface 4 to which the ink 41 is transferred is pressed against the surface 70a that has a curved surface or an irregular surface, thereby forming a layer of the ink 41 on the surface 70a. In the printing apparatus 100 according to Embodiment 1, since the ink 41 can be relatively thickly deposited on the printing original plate 50, the layer of the ink 41 that is formed on the surface 70a can be made thick. The ink 41 can be adapted to the solid printing with the configuration of the openings 23 of the screen 21. Therefore, in the printing apparatus 100 according to Embodiment 1, a uniform ink layer (coating layer) can be formed on a surface of, for example, a body of an automobile. As compared with the case where coating is performed with paint whose viscosity is reduced by a solvent such as thinner by, for example, an air spray as in the related art, scattering do not occur because ink (paint) having high viscosity is used. Therefore, because a coating line is obtained using such a printing apparatus 100, processing facilities such as a ventilation apparatus and an air purification apparatus are unnecessary, or it is possible to reduce the number of such processing facilities, and also to reduce the use of pain (ink) necessary for coating.

### Method of Producing Printed Object Using Printing Apparatus 100

The method of producing a printed object 70 using the printing apparatus 100 will be described with reference to FIGS. 1, 2 and 5. As illustrated in FIG. 2, the printing apparatus 100 includes a controller 90. The controller 90 is, for example, a microcomputer, and includes a calculation device 90a and a storage device 90b. Functions of the controller 90 are fulfilled by the calculation device 90a and the storage device 90b (see FIG. 2).

The storage device 90b is a ROM that holds programs and data in advance, a RAM that temporarily stores data in running of a program, or other memories. Furthermore, as the storage device 90b, for example, a nonvolatile or volatile semiconductor memory such as a flash memory, an erasable and programmable ROM (EPROM), or an electrically erasable and programmable ROM (EEPROM) is used. Also, as the storage device 90b, for example, a detachable recording medium such as a magnetic disk, a flexible disk, an optical disc, a compact disc (CD), a mini disc (MD), or a digital versatile disc (DVD) may be used. The storage device 90b can store information obtained from a temperature sensor 68 or other sensors, and information processed by the calculation device 90a. In addition, the storage device 90b stores a program for an operating system (OS), various kinds of application programs, data recorded in a database, etc. These programs and data fulfills various kinds of functions in cooperation with hardware resources by calculation processing of the CPU.

The calculation device 90a performs various kinds of processing for fulfilling the functions of the controller 90. For example, the calculation device 90a compares information on a room temperature obtained by a temperature sensor or other sensors, with a threshold of a temperature that is stored in advance in the storage device 90b, and determines whether the room temperature is higher than the threshold. When the room temperature is higher than the threshold, the controller 90 performs a control to reduce the output of a heater included in the blower 66 to a predetermined value. Furthermore, when the room temperature is higher than the threshold, the controller 90 may perform a control to shorten the operating time of the blower 66, or the controller 90 may perform a control to limit a time when the printing pad 10 stops in front of the blower 66 to receive the air. In addition, the controller 90 may perform a control to change a printing condition based on a target object 70 to be printed by the printing apparatus 100. For example, in the case where the surface 70a to be printed of the object 70 has irregularities and thus has a complicated shape, the controller 90 may perform a control to reduce a pressing speed of the printing pad 10 against the surface 70a. In addition, the controller 90 can be configured to appropriately control the operation of each of the components of the printing apparatus 100.

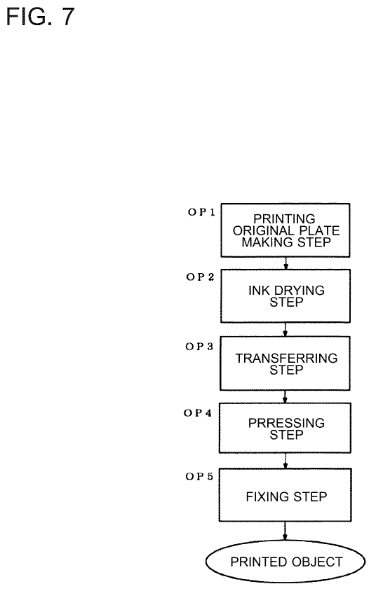

FIG. 7 indicates a flow of the method of producing a printed object 70 using the printing apparatus 100 according to Embodiment 1. An outline of the method of producing the printed object 70 will be described with reference to FIG. 7.

### Printing Original Plate Making Step OP1 of Making Printing Original Plate

As illustrated in FIG. 7, in the method of producing the printed object, a printing original plate making step OP1 of forming a print image on the deposition surface 51 of the printing original plate 50 is first carried out. In the printing original plate making step OP1, ink is deposited on the printing original plate 50 by the ink depositing device 20 as illustrated in FIG. 5. As illustrated in FIG. 2, the printing original plate 50 is formed in the shape of, for example, a flat plate, and is placed on the printing original plate stage 85. In Embodiment 1, the printing original plate 50 is a thin flat plate made of an aluminum alloy; however, a sheet material that is referred to as a “receptor sheet” and is excellent in retainability and affinity for the ink 41 can also be used. In addition, it is possible to increase the retainability and affinity for the ink in the sheet material by causing the sheet material to have irregularities. The surface of the printing original plate 50 is finished in such a manner as to have predetermined surface roughness, and is configured such that ink 41 from the openings 23 of the screen 21 adheres to the surface of the printing original plate 50. However, even in the case where the printing original plate 50 is set to have high affinity for the ink 41, the material and the structure are not limited. For example, in some cases, no irregularity is provided on the sheet material. It is allowable that the printing original plate 50 such as the sheet material is not used and the surface of the printing original plate stage 85 is used as the printing original plate 50.

As the printing original plate 50, a printing original plate having low affinity for the ink 41 may be used. In the case where the printing according to Embodiment 1 is applied to coating of a body of an automobile, so-called solid printing is performed. At this time, a relatively large amount of ink 41 is deposited on the printing original plate 50. Therefore, when the ink 41 is transferred from the printing original plate 50 to the printing pad 10, part of the ink 41 on the printing original plate 50 may remain without being transferred to the printing pad 10. In the case where the printing original plate 50 having low affinity for the ink 41 is used, the rate of transfer of the ink 41 to the printing pad 10 is improved. This is an advantage. For example, the printing original plate 50 may be made of a film having low affinity for the ink 41. The surface of the printing original plate 50 may be coated with a fluorine resin or other substances, or may be subjected to treatment for reducing its surface roughness or other treatment. In other words, it suffices that the printing original plate 50 is subjected to treatment for reducing its affinity for the ink 41, based on material that is applied to the ink 41. In the printing apparatus 100 according to Embodiment 1, when the ink 41 is deposited on the printing original plate 50 using the screen 21, the ink 41 is pushed out from the openings 23 by pressure from the squeegee 30. Thus, even in the case where the affinity of the printing original plate 50 for the ink 41 is low, the ink 41 is easily transferred to the printing original plate 50.

### Ink Drying Step OP2

After the printing original plate making step OP1 ends, an ink drying step OP2 is carried out. Immediately after the printing original plate making step OP1 ends, the viscosity of the ink 41 on the printing original plate 50 is low. If the viscosity of the ink 41 on the printing original plate 50 remains low, the ink 41 may spread and not be transferred with high accuracy when the printing pad 10 is pressed against the printing original plate 50. In addition, a print image may not be precisely formed due to, for example, bleeding of the ink 41. Therefore, in the ink drying step OP2, the solvent contained in the ink 41 is evaporated to increase the viscosity of the ink 41. It should be noted that when the ink 41 deposited on the printing original plate 50 by the ink depositing device 20 has proper viscosity, the ink drying step OP2 can be omitted.

In the ink drying step OP2, for example, the ink 41 on the printing original plate 50 is heated by a heater 53 to evaporate the solvent in the ink 41. The ink 41 may be dried by other means such as blown air, or may be naturally dried for a predetermined time while the printing original plate 50 is kept deposited on the printing original plate stage 85. The volatility of the solvent contained in the ink 41 is higher than that of each of the other components in the ink 41. Therefore, the solvent is evaporated from the ink 41 by, for example, sending air thereto to increase the ratio of the components other than the solvent in the ink 41, thereby increasing the viscosity of the ink. At the time at which the ink drying step OP2 is completed, the viscosity of the ink 41 is adjusted to, for example, 3 Pa·s to 1000 Pa·s. It is preferable that time for which the ink is dried be made to coincide with the time required for subsequent steps, that is, a transferring step OP3 and a pressing step OP4. By providing such a configuration as described above, it is possible to continuously and efficiently print a number of objects 70 to be printed.

The step may proceed from the printing original plate making step OP1 to the ink drying step OP2 after the printing original plate 50 is moved from the printing original plate stage 85 or while the printing original plate 50 is kept deposited on the printing original plate stage 85. In the case where the printing original plate 50 is moved from the printing original plate stage 85, another printing original plate 50 can be immediately placed on the printing original plate stage 85, and the printing original plate making step OP1 can be started. Therefore, the cycle time of the entire offset printing step can be reduced.

In the case where the ink 41 on the printing original plate 50 is dried by blown air, for example, a blower and a heater may be installed alongside of the ink depositing device 20, and air that has passed through the heater may be sent onto the printing original plate 50 by the blower. It is appropriate that the heater installed together with the blower is set such that the temperature of air that is sent reaches the highest possible temperature that is lower than a boiling point of the solvent contained in the ink 41. As the solvent contained in the ink 41, a solvent that is half dried in the ink drying step OP2 is selected. For example, a solvent that has a flash point of 40 degrees C. or higher and a boiling point of 120 degrees C. or higher is selected. At this time, the temperature of the heater is set to, for example, 100 degrees C. It is preferable that the solvent have low solvency because the solvent having high solvency may damage the ink depositing device 20. However, the ink 41 for use in the printing apparatus 100 is not limited to such ink as described above.

### Transferring Step OP3

In the transferring step OP3, in the case where printing is performed using the printing pad 10 that has a curved surface such as a parabolic surface, the printing pad 10 is pressed against the printing original plate 50 from its apex, whereby a print image formed by the ink 41 on the printing original plate 50 is transferred to the printing pad 10.

### Pressing Step OP4

In the pressing step OP4, the printing pad 10 is pressed against the object 70 to be printed. The ink 41 adhering to the surface of the printing pad 10 is transferred to the surface of the object 70. In the case where printing is performed using the printing pad 10, the printing can be performed in such a manner as to follow the shape of the surface of the object 70 even though the surface of the object 70 has a curved surface. Before the pressing step OP4 is carried out, the object 70 is positioned. The object 70 may be positioned using a jig or a tool. In the case where the pressing step is carried out on the object 70 a plurality of times, the jig may be changed to change the orientation of the object 70 each time the pressing step is carried out, and the object 70 may be adjusted such that the printing pad 10 is pressed against the surface 70a to be printed at a desired position and a desired angle. In the case where the printing pad 10 is moved by a robot arm, the angle at which the printing pad 10 is pressed against the surface 70a can be changed. Therefore, the jig that supports the object 70 need not to be changed.

### Fixing Step OP5

In a fixing step OP5, the ink 41 transferred onto the surface of the object 70 to be printed in the pressing step OP4 is fixed. In the case where UV ink is used as the ink 41, an ultraviolet irradiation device (not illustrated) may irradiate the surface of the object 70 with ultraviolet rays, to cure the ink 41. Alternatively, the surface of the object 70 may be irradiated with an electron beam instead of the ultraviolet rays. In the case where the object 70 includes a curved surface, it is preferable that an ultraviolet irradiation device 80 that can irradiate ultraviolet rays along the curved surface be used.

In the fixing step OP5, the way of curing the ink 41 is not limited to irradiation with ultraviolet rays or an electron beam. For example, the ink 41 may be cured by heating by a heater, or may be and dried and cured by blown air. Alternatively, the ink 41 may be cured by natural drying.

### Operation of Printing Apparatus 100

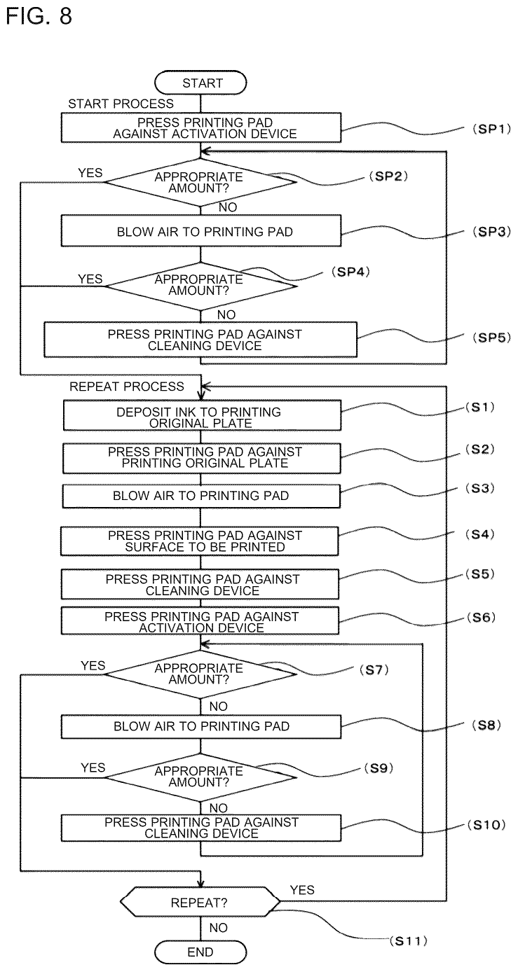

FIG. 8 indicates the flow of an operation of the printing apparatus 100 according to Embodiment 1. In the case of applying the method of producing the printed object as illustrated in FIG. 7 described above, the printing apparatus 100 operates according to the flow indicated in FIG. 8.

### Starting Step

A starting step is carried out immediately after the printing apparatus 100 is started up. Since the surface of the printing pad 10 may not be activated immediately after production of a printed object is started, a step of properly activating the printing surface 4 of the printing pad 10 is carried out. After the printing apparatus 100 is started up, in the printing apparatus 100, the printing pad 10 is moved to a region located above the activation device 61, and is then moved down toward the activation device 61. After the printing surface 4 of the printing pad 10 is pressed against the absorption unit of the activation device 61, and a predetermined part of the printing pad 10 that includes the printing surface 4 thus comes into contact with the absorption unit, the printing pad 10 is moved upward. This will be referred to as an activation step (SP1). As a result, the liquid such as water and a solvent that permeates into the absorption unit of the activation device 61 adheres to or permeates into the printing surface 4 of the printing pad 10. It should be noted that the printing pad 10 has irregularities at its surface, and the liquid permeating into the absorption unit easily adheres to or permeates into the printing pad 10. This step may be referred to as a first starting step.

After the first starting step is completed, it is determined whether the amount of liquid adhering to the printing surface 4 of the printing pad 10 is appropriate or not (SP2). In the case where the amount of liquid adhering to the printing surface 4 is not appropriate (NO in SP2), the printing apparatus 100 performs an air blowing step (SP3). In the air blowing step, the air blowing device 62 blows air to the printing surface 4 of the printing pad 10 to remove surplus liquid adhering to the printing surface 4. The case where the amount of liquid adhering to the printing surface 4 is not appropriate means the case where the liquid excessively adheres to the printing surface 4. The above air blowing step may be referred to as a second starting step.

After the second starting step is completed, it is determined whether the amount of liquid adhering to the printing surface 4 of the printing pad 10 is appropriate or not (SP4). In the case where surplus water or solvent adheres to the printing surface 4 of the printing pad 10 (NO in SP4), the printing apparatus 100 performs an absorption step (SP5). In the absorption step, in the printing apparatus 100, the printing surface 4 of the printing pad 10 is pressed against the cleaning device 60. As a result, the surplus liquid adhering to the printing surface 4 of the printing pad 10 is removed. The above cleaning step may be referred to as a third starting step.

In the case where the amount of water or solvent adhering to or permeating into the printing pad 10 is appropriate, one or both of the air blowing step (SP3) and the absorption step (SP5) may be omitted. Furthermore, the order in which the air blowing step and the absorption step are carried out may be changed. In addition, the air blowing step (SP3) and the absorption step (SP5) in the starting step may be carried out a plurality of times.

In the step of determining whether the amount of liquid adhering to the printing surface 4 of the printing pad 10 is appropriate or not (SP2 and SP4), this determination may be made by a sensor or through a visual inspection by a worker. In the case where the determination is made through a visual inspection by the worker, the worker operates an operation panel (not illustrated) to determine whether to cause the processing proceed to a subsequent step or repeat a preceding step.

### Repetition Step

After the starting step is completed, and the printing surface 4 of the printing pad 10 is properly activated, the processing proceeds to a repetition step. The repetition step includes an ink deposition step (S1), an ink transferring step (S2), a drying step (S3), a pressing step (S4), a cleaning step (S5), an activation step (S6), an air blowing step (S8), and an absorption step (S10). As illustrated in FIG. 8, the printing apparatus 100 carries out the ink deposition step (S1), the ink transferring step (S2), the drying step (S3), the pressing step (S4), the cleaning step (S5), the activation step (S6), the air blowing step (S8), and the absorption step (S10) in this order. However, in the repetition step, the order in which the above steps are carried out is not limited to the above order. For example, after the ink deposition step (S1) and the ink transferring step (S2) are completed, the printing apparatus 100 carries out the remaining steps from the drying step (S3) to the absorption step (S9). In this case, the printing apparatus 100 may carries out the ink deposition step (S1) of a subsequent cycle in parallel while carrying out the steps from the drying step (S3) to the absorption step (S9).

The ink deposition step (S1) corresponds to the printing original plate making step OP1 in the method of producing the printed object that is indicated in FIG. 7. The ink transferring step (S2) corresponds to the transferring step OP3 in the method of producing the printed object that is indicated in FIG. 7. Before the pressing step (S4), the drying step (S3) of sending air to the printing surface 4 of the printing pad 10 to increase the viscosity of the ink 41 on the printing surface 4 may be carried out. Whether or not to carry out the drying step (S3) may be determined depending on the viscosity of the ink 41 on the printing original plate 50. The pressing step (S4) corresponds to the pressing step OP4 in the method of producing the printed object that is indicated in FIG. 7. It should be noted that in the printing apparatus 100 according to Embodiment 1, a step of moving the printing pad 10 to a region located above the object 70 is applied between the ink transferring step (S2) and the pressing step (S4). A step that includes the ink transferring step (S2), the step of moving the printing pad 10 to the region located above the object 70, and the pressing step (S4) may be referred to as a printing step.

In the repetition step, a single print image region is completely formed each time the pressing step (S4) is carried out once. For example, in the object 70 as illustrated in FIG. 1, the repetition step may be carried out a plurality of times while the position of the printing pad 10 is being changed, and the pressing steps (S4) may be carried out a plurality of times, whereby an ink layer is formed on an entire region of a top surface of an automobile.

### Cleaning Step

In the cleaning step (S5), after the ink 41 is transferred to the surface to be printed, the printing surface 4 of the printing pad 10 is pressed against a flat cleaning surface of the cleaning device 60. The ink 41 remaining on the printing pad 10 is caused to adhere to the cleaning surface. The cleaning surface is made of paper or an adhesive tape, but is not limited thereto.

### Activation Step, Air Blowing Step, and Absorption Step

The activation step (S6) is the same in processing as the activation step (SP1) in the starting step. The air blowing step (S8) is the same in processing as the air blowing step (SP3) in the starting step. The absorption step (S10) is the same in processing as the absorption step (SP5) in the starting step. The air blowing step (S8) and the absorption step (S10) are carried out based on the amount of liquid such as water or a solvent that adheres to the printing surface 4 of the printing pad 10. One of the air blowing step (S8) and the absorption step (S10) may be omitted, or at least one of the air blowing step (S8) and the absorption step (S10) may be carried out a plurality of times. Each of the air blowing step (S8) and the absorption step (S10) is carried out based on the activation state of the printing surface 4 of the printing pad 10 after the state of the printing surface 4 is checked before each of the steps. In the case where the state of the printing surface 4 of the printing pad 10 is checked in a checking step (S7 and S9), and the activation state of the printing surface 4 is proper, it is determined whether or not to re-carry out the printing in a repetition determination step (S11). In the case where the printing is re-carried out (YES in S11), the steps from the ink deposition step (S1) are repeated again. In the case where the printing is not repeated (NO in S11), production of a printed object is ended.

As described above, the printing apparatus 100 carries out the starting step at startup and then carries out the repetition step, thereby performing printing on a number of objects 70 to be printed. When the printing pad 10 is in the activated state, the above starting step (SP1 to SP5) may be omitted.

### Details of Ink Deposition Step S1

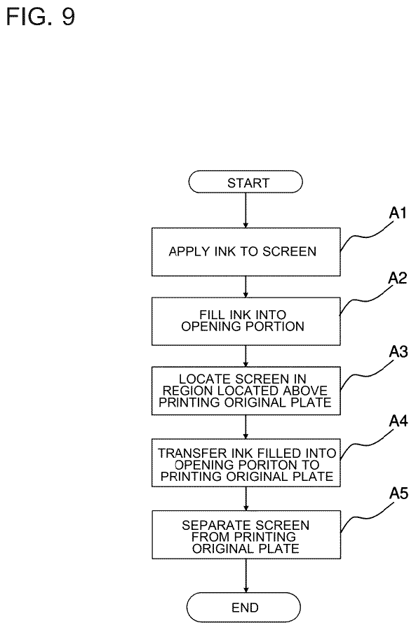

FIG. 9 indicates a detailed flow of operation in the ink deposition step (S1) according to Embodiment 1. As indicated in FIG. 5, in the ink deposition step (S1), a step of applying the ink 40 onto the screen 21 is first carried out (A1). In this step, the ink 40 may be applied such that the ink 40 spreads over the screen 21. Alternatively, the ink 40 may be deposited on part of the screen 21. In the case where the ink 40 is deposited on part of the screen 21, the ink 40 is spread to reach the openings 23 of the screen 21 by movement of the squeegee 30, such that the openings 23 can be filled with the ink 40.

Next, the squeegee 30 moves while sliding along the surface of the screen 21 (A2). When the squeegee 30 moves while sliding along the surface of the screen 21, the ink 40 is spread over the screen 21. At this time, the openings 23 are filled with the ink 40. It should be noted that an ink filling step (A2) may be omitted in the case where the openings 23 are already filled with the ink 40. The ink filling step (A2) is carried out by the squeegee 30, but may be carried out using a dedicated filling squeegee.

Next, the screen 21 to which the ink 40 is applied is located in a region located above the printing original plate 50 (A3). The screen 21 and the printing original plate 50 are disposed, with a gap of, for example, approximately 1 mm interposed between the screen 21 and the printing original plate 50. The screen 21 is provided at a predetermined position with reference to the printing original plate 50. The screen 21 may be positioned by bringing the screen frame 22 into contact with, for example, a jig, or by using a mechanism by which the screen 21 or the printing original plate 50 can be moved to a predetermined position. In a step of locating the screen 21 in the region located above the printing original plate 50, the screen 21 or the printing original plate 50 is moved.

For example, the printing original plate 50 is moved alternately to a position where the ink deposition step (S1) is carried out and a position where the transferring step (S2) is carried out. In this case, the printing original plate 50 may be moved by a slide mechanism or other mechanisms to a determined position in each of the ink deposition step (S1) and the transferring step (S2). Alternatively, the screen 21 may be moved by the slide mechanism or other mechanisms. For example, in the case where the printing original plate 50 is fixed or in the case where the surface of the printing original plate stage 85 serves as the printing original plate 50, the screen 21 is moved.

Thereafter, when the squeegee 30 moves while sliding over the surface of the screen 21, and the screen 21 is pressed against the printing original plate 50, the ink 40 filled into the openings 23 is transferred to the printing original plate 50 (A4). At this time, the squeegee 30 slides over the surface of the screen 21 while receiving a predetermined load toward the screen 21. As a result, the screen 21 is pressed against the printing original plate 50 by the squeegee 30. That portion of the screen 21 against which the squeegee 30 is pressed comes into close contact with the surface of the printing original plate 50. The ink 41 filled into the openings 23 is pressed together with the screen 21, against the printing original plate 50 by the squeegee 30, and thus comes into contact with and adheres to the surface of the printing original plate 50. It should be noted that referring to FIG. 5, by one squeegee 30, the ink 40 is filled into the openings 23 (A2) and the ink 40 is transferred from the screen 21 to the printing original plate 50 (A4); however, the squeegee 30 may include a filling squeegee and a transfer squeegee.

After the squeegee 30 moves while sliding over a predetermined region of the screen 21, the screen 21 is separated from the printing original plate 50 (A5). This step may be achieved by movement of the screen 21 or the printing original plate 50. For example, the screen 21 and the printing original plate 50 are separated by movement of the printing original plate 50 to the position where the transferring step (S2) is carried out.

When the repetition step as indicated in FIG. 8 is carried out a plurality of times, in some cases, the step of applying the ink 40 onto the screen 21 (A1) is omitted. In other words, in the case where the ink 40 applied in a previous cycle sufficiently remains on the screen 21, it suffices that the remaining ink 41 is deposited on the printing original plate 50. The step of locating the screen 21 in the region located above the printing original plate 50 (A3) may be carried out before the step of applying the ink (A1) or the step of filling the openings 23 with the ink (A2).

### Modification of Printing Pad 10

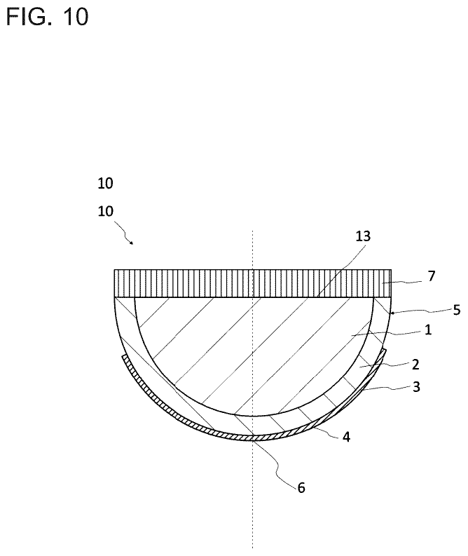

FIG. 10 illustrates a modification of the printing pad 10 for use in the printing apparatus 100 of Embodiment 1. The printing pad 10 according to Embodiment 1 may include a protective film layer 3 that covers a surface of the base 5. The protective film layer 3 forms the printing surface 4 that is an outer surface of the printing pad 10. The protective film layer 3 is formed by, for example, bonding a sheet made of a silicone rubber and having a thickness of 0.5 mm to the surface of the external layer 2. The protective film layer 3 also prevents silicone oil contained in the soft silicone rubber therein from oozing to the printing surface 4. An outer surface of the protective film layer 3 is required to have durability against scratches and wear, because the outer surface of the protective film layer 3 forms the printing surface 4 and is repeatedly pressed against the printing original plate 50 and the surface to be printed. Therefore, the protective film layer 3 is made of material having high hardness for the external layer 2, and is thin in such a manner as to follow the surface to be printed when the printing surface 4 is pressed against the surface to be printed.

In Embodiment 1, the thickness of the protective film layer 3 is set as small as possible, and it is appropriate that the thickness of the protective film layer 3 is set to fall, for example, within the range of 0.1 to 1 mm. The material of the protective film layer 3 is not limited to the silicone rubber, and as the material, any material can be selected as long as the material enables the protective film layer 3 to follow deformation of the internal layer 1 and the external layer 2. In addition, it is preferable that the protective film layer 3 have sufficient stretchability that enables the protective film layer 3 to be bonded along the surface of the base 5 in a step of bonding the protective film layer 3 to the base 5. Furthermore, the printing pad 10 may be formed to have a multilayer structure. For example, the internal layer 1 or the external layer 2 of the printing pad 10 as illustrated in FIG. 10 may be formed to have a multilayer structure made of materials having different hardness.

The protective film layer 3 is bonded to the surface of the base 5 (surface of the external layer 2); however, when damage such as scratches and wear occurs, the protective film layer 3 can be peeled from the surface of the base 5 and replaced by a new protective film layer. The protective film layer 3 is inexpensive as compared with the base 5, and the base 5 located therein can be used as it is by replacement of the protective film layer 3. Therefore, by replacing the protective film layer 3 by a new one, it is possible to repeatedly use the expensive base 5, whereby it is possible to keep the printing surface 4 of the printing pad 10 suitable for printing. Furthermore, in the printing apparatus 100 according to Embodiment 1, it is possible to reduce the cost necessary for printing. The external layer 2 that forms the base 5 is softer than the internal layer 1, and can thus sufficiently follow the shape of the object 70 to be printed. In the case where the external layer 2 is damaged by a high load applied thereto through the protective film layer 3, the surface of the external layer 2 may be hardened because of repetition of replacement of the protective film layer 3 as described above. In this case, the external layer 2 can also be replaced by a new one. Because of replacement of the external layer 2, it is possible to use the internal layer 1 for a long time. It should be noted that referring to FIGS. 3 and 10, the base 5 includes the internal layer 1 and the external layer 2, but may include only one internal layer 1. That is, the protective film layer 3 may be provided on the base 5 that includes only one internal layer 1. However, in the case where the base 5 may be damaged by work of peeling the protective film layer 3 at the time of replacing the protective film layer 3 bonded to the base 5 by a new one, the printing surface 4 of the printing pad 10 may be deeply scratched, or the surface of the base 5 may be deteriorated, for example, hardened. Therefore, it is preferable that the base 5 have multiple layers as illustrated in FIGS. 3 and 10.

### Printing Surface 4 of Printing Pad 10

It is appropriate that the printing surface 4 that is the surface of the printing pad 10 and that is pressed against the printing original plate 50 has fine irregularities depending on the thickness of the ink 41 for use in printing. In the printing apparatus 100 according to Embodiment 1, by depositing the ink 41 on the printing original plate 50 by using the screen 21, it is possible to increase the thickness of the ink 41 that is deposited on the printing original plate 50. By causing the printing surface 4 to have irregularities depending on the thickness of the ink 41 on the printing original plate 50, it is possible to cause the ink 41 that is transferred to the printing pad 10 to be thick as compared with the related art.

In transfer of relatively thick ink 41 to the printing surface 4 of the printing pad 10, it is appropriate that irregularities are formed on the surface of the printing pad 10. The irregularities are formed by, for example, transfer of an irregular shape of a surface of a die at the time of molding the printing pad 10. Alternatively, in the printing pad 10 as illustrated in FIG. 10, at the time of molding the protective film layer 3 to be bonded to the surface of the base 5, the surface of the protective film layer 3 may be formed to have an irregular shape. In the printing pad 10 as illustrated in FIG. 10, the protective film layer 3 that is a member having a sheet shape is formed to have the irregular shape, whereby it is possible to easily obtain a desired irregular shape. Furthermore, by replacing the protective film layer 3 by a new one, it is possible to easily change, for example, a height difference between the highest portion and the lowest portion of an irregular shape 14, a detailed shape of the irregularities, or the hardness of the protective film layer 3. In particular, in the case of the printing pad 10 for use in printing of a component or components related to an automobile, the base 5 is made larger. Therefore, when the height difference and other factors are adjustable by change of only the protective film layer 3 on the surface, it is advantageous in terms of, for example, the cost and a production period.

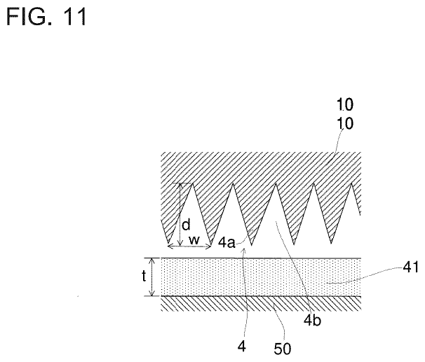

In the case where the height difference between the highest portion and lowest portion of an irregularly shaped surface of the protective film layer that has been molded is a desired value, the protective film layer 3 may be bonded to the base 5 as it is. However, in the case where the height difference d (see FIG. 11) between the highest portion and the lowest portion of the irregularly shaped surface is greater than the desired value, a surface of a sheet that forms the protective film layer 3 may be rubbed with an abrasive such as an abrasive cloth and paper to abrade protrusions 4a (see FIG. 11), that is, high portions of the irregularly shaped surface. Alternatively, an abrasive sponge such as a melamine sponge may be used. In other words, the surface of the sheet forming the protective film layer 3 may be formed in a rough state, and its state may be then adjusted and changed to a state in which it facilitates transfer to the printing surface 4, by treatment such as polishing. It should be noted that the above description refers to the case where the printing pad 10 includes the protective film layer 3; however, in the case where the protective film layer 3 is not included in a printing pad as in the printing pad 10 that is provided as illustrated in FIG. 3, the surface of the base 5 may be roughly formed in advance, and the irregular shape of the surface may be gradually adjusted by polishing or other treatment.

The height difference between the highest portion and the lowest portion of the irregular shape 14 is set based on the thickness of the ink 41 deposited on the printing original plate 50. The thickness of the ink 41 deposited on the printing original plate 50 is adjusted based on the thickness h of the screen 21 as illustrated in FIG. 6. Therefore, the height difference d of the irregular shape 14 of the printing surface 4 of the printing pad 10 is set based on the thickness h of the screen 21.

For example, in coating of an automobile, the thickness of a coating layer formed by single coating is 10 to 20 μm. To be more specific, in the case where the printing apparatus 100 of Embodiment 1 is applied to coating of the automobile, it is appropriate that in the ink deposition step (S1), the thickness of the ink 41 deposited on the deposition surface of the printing original plate 50 is set to 10 to 20 μm. Therefore, it is appropriate that the height difference between the highest portion and the lowest portion of the irregular shape 14 of the printing surface 4 of the printing pad 10 is also set to 10 to 20 μm. However, in the case where it is hard to form the ink layer having a thickness of 10 to 20 μm on the surface 70a to be printed, by single printing, it is appropriate that the printing is performed a plurality of times.

The thickness of the ink layer on the printing original plate 50 (thickness of ink 41 as illustrated in FIGS. 5 and 6) is nearly equal to the thickness of the screen 21. The height difference between the highest portion and the lowest portion of the irregular shape of the printing surface 4 is set slightly smaller than the thickness h of the screen 21 to facilitate transfer of the ink. In other words, the thickness h of the screen 21 is set greater than the height difference of the irregular shape of the printing surface 4 of the printing pad 10.

Furthermore, in some cases, the height difference between the highest portion and the lowest portion of the irregular shape of the printing surface 4 is represented by a maximum height roughness Rz or a three-dimensional surface roughness Sz. The surface roughness Rz and Sz of the printing surface 4 are measured by a non-contact roughness meter. The height difference between the highest portion and the lowest portion of the irregular shape may be set based on the surface roughness Rz and Sz measured by the non-contact roughness meter.

FIG. 11 is an enlarged schematic view of the printing surface 4 of the printing pad 10 according to Embodiment 1. The irregular shape of the printing surface 4 is deformed in a direction in which the height difference d is reduced when the printing surface 4 is pressed against the printing original plate 50. Therefore, it is appropriate that the irregular shape is set such that the height difference d that corresponds to a dimension from an apex of each of the protrusions 4a to an associated one of valleys 4b is greater than the distance between the apexes of the adjacent protrusions 4a. Although FIG. 11 illustrates a substantially uniform irregular shape of the printing surface 4, but actually, the apexes of the protrusions 4a and bottoms of the valleys 4b are not located at regular intervals. Therefore, it is appropriate that actually, the values of the surface roughness Rz and Sz are compared with an average value of intervals w between the apexes of the protrusions 4a, and the values of the surface roughness Rz and Sz are set greater than the average value of the intervals w between the apexes of the protrusions 4a.

In the case where the surface roughness is high, when printing is performed by the printing pad 10, a surface of a product (surface of an ink layer) may become rough, in particular, in solid printing. In this case, it is possible to smoothen the surface of the product by setting the viscosity of the ink to a low value, for example, 10 Pa·s (100 poise) or less. However, the viscosity of the ink is not limited to the above value.

Although the present disclosure is applied based on the embodiment, the present disclosure is not limited to the configurations according to the embodiment. In particular, combinations of components is not limited to the combinations of components in the embodiment, and can be appropriately changed. Furthermore, it should be noted that various modifications, applications, and utilizations that are made by a person with ordinary skilled in the art as necessary are also encompassed in the gist (technical scope) of the present disclosure.

### Reference Signs List

1: internal layer, 2: external layer, 3: protective film layer, 4: printing surface, 4a: protrusion, 4b: valley, 5: base, 6: apex, 7: supporting member, 10: printing pad, 11: up-down-direction moving device, 12: horizontally moving device, 13: flat surface, 14: irregular shape, 15: height difference, 20: ink depositing device, 21: screen, 22: screen frame, 23: opening, 24: mesh member, 24a: fiber, 24b: fiber, 24c: gap, 25: emulsion, 30: squeegee, 40: ink, 41: ink, 50: printing original plate, 51: deposition surface, 53: heater, 60: cleaning device, 61: activation device, 62: air blowing device, 66: blower, 68: temperature sensor, 70: object to be printed, 70a: surface to be printed, 74: peripheral edge, 75: connection region, 75a: connection region, 75b: connection region, 80: ultraviolet irradiation device, 85: printing original plate stage, 86: surface treatment stage, 87: printing stage, 90: controller, 90a: calculation device, 90b: storage device, 100: printing apparatus, d: height difference, h: thickness, w: interval.

1. A printing apparatus comprising:
a printing pad having a printing surface that has irregularities and is deformable in such a manner as to conform to a shape of a surface to be printed of an object to be printed;
a printing original plate having a deposition surface on which ink is to be deposited; and
an ink depositing device configured to deposit the ink on the surface of the printing original plate in such a manner as to also adapt to solid printing in which a predetermined print region of the surface of the object is filled with ink without any gaps,
wherein
the printing pad is configured to be movable between the printing original plate and the object to be printed, and to be pressed against the printing original plate or the object, and
the ink depositing device includes
a screen that includes openings through which the ink passes, and
a squeegee configured to slide over a surface of the screen.

2. The printing apparatus of claim 1, wherein the squeegee is configured to slide over the surface of the screen on which the ink is deposited, to cause the ink to pass through the openings.

3. The printing apparatus of claim 1, wherein the screen is a fabric woven of metal fibers.

4. The printing apparatus of claim 1, wherein the screen is a fabric woven of resin fibers.

5. The printing apparatus of claim 1, wherein the openings of the screen are provided by formation of holes that is carried out by processing that is performed on a metal plate or a resin plate.

6. The printing apparatus of claim 3, wherein the screen has at least a portion to which solidified emulsion is fixed, and portions of the screen to which the emulsion is not fixed serve as the openings.

7. The printing apparatus of claim 1, wherein a three-dimensional surface roughness Sz of the printing surface of the printing pad is set to a value that increases as a thickness of the screen increases.

8. The printing apparatus of claim 7, wherein the thickness of the screen is set greater than the value of the three-dimensional surface roughness Sz of the printing surface of the printing pad.

9. The printing apparatus of claim 1, wherein the squeegee is configured to slide over the surface of the screen while pressing the screen against the printing original plate, with the screen on which the ink is deposited provided above the printing original plate.

10. The printing apparatus of claim 1, wherein the surface of the printing original plate is subjected to surface treatment to cause the surface to have a low affinity for the ink.

11. The printing apparatus of claim 1, wherein the printing original plate is part of a surface of a printing original plate stage.

12. The printing apparatus of claim 1, wherein
the ink depositing device is provided on a printing original plate stage, and
the printing original plate stage is configured to be movable.

13. A method of producing a printed object by pressing a printing surface of a printing pad against a surface to be printed of the object to be printed to transfer ink deposited on the printing surface, thereby forming an ink layer on the surface to be printed, the printing surface of the printing pad having irregularities, the method comprising:
depositing the ink on a surface of a printing original plate in such a manner as to also adopt to solid printing in which a predetermined print region of the surface of the object is filled with ink without any gaps, by sliding a squeegee along a surface of a screen after the ink is deposited on the screen, and causing the ink to pass through openings provided in the screen;
transferring the ink deposited on the printing original plate to the printing surface by pressing the printing surface against the printing original plate on which the ink is deposited; and
pressing the printing surface against the surface of the object to be printed while deforming the printing surface in such a manner as to conform to the surface of the object, thereby forming the ink layer.
